(19) United States
(12) Patent Application Publication
(10) Pub. No.: US 2005/0204510 A1
(43) Pub. Date: Sep. 22, 2005

(54) Hidden hinge with 270 degree rotation

(75) Inventors: Raymond A. Heimann, Newton, IA (US); Troy A. Johnson, Newton, IA (US); Joseph M. Keeler, Colfax, IA (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/803,708

(22) Filed: Mar. 18, 2004

(51) Int. Cl. E05D 7/06

(52) U.S. Cl. 16/366

(57) ABSTRACT

A cabinet with a door is provided with an improved hinge. The hinge includes a door leaf mounted within the door, a cabinet leaf mounted on an exterior portion of the cabinet and intermediate leaf extending between the door leaf and the cabinet leaf. The intermediate leaf includes a curved arm having one end connected to the door leaf by a first end and an opposite end connected to the cabinet leaf by a second pin. The first and second pins define pivot points for the hinge, which allow the door to open approximately 270° from the closed position. In a door with a seal, the order of hinge leaf operation is controlled to minimize damage and wear to the seal.

### BACKGROUND OF THE INVENTION

Doors for appliances and cabinets come with a variety of hinges to suit multiple needs, however, most hinges limit movement to approximately 180° from a closed position to a fully open position. It may be desirable to open the door beyond 180°, for example approximately 270° so that the doors fold backward adjacent the sides of the appliance or cabinet. Also, hinges having multiple degrees of freedom wherein at least three hinge leaves are provided with at least two hinge pins or pivot points are known, but typically do not have any control to the order of rotation of the leaves. Such control of the rotation is desirable to eliminate damage or wear to door seals. Most hinges are also mounted on surfaces of the cabinet and doors, which detracts from the aesthetics of the product. Therefore, it is desirable to hide part of the hinge inside the door.

A primary objective of the present invention is the provision of an improved hinge pivotally connecting a door to a cabinet, such as an appliance cabinet.

Another objective of the present invention is the provision of a door hinge having multiple degrees of freedom which allow the door to pivot substantially 270° between closed and open positions.

A further objective of the present invention is the provision of a cabinet door hinge which is partially hidden within the door.

Still another objective of the present invention is the provision of a cabinet door hinge having a controlled order of operation of multiple hinge leaves during the opening and closing of the door.

Another objective of the present invention is the provision of a door hinge having a door leaf, a cabinet leaf, and an intermediate leaf interconnecting the door and cabinet leaves, and with the torsional resistance of the intermediate-to-cabinet leaves being greater than the torsional resistance of the intermediate-to-door leaves, so as to ensure full pivotal closure of the intermediate-to-door leaves prior to pivot of the intermediate-to-cabinet leaves.

Another objective of the present invention is the provision of a hinge for a cabinet having a door, wherein the hinge is economical to manufacture and durable and safe in use. These and other objectives will become apparent from the following description of the invention.

### SUMMARY OF THE INVENTION

The hinge of the present invention pivotally connects a door to a cabinet, such as an appliance door and cabinet. The hinge includes a door leaf mounted within the door and a cabinet leaf mounted on an exterior surface of the cabinet. An intermediate leaf interconnects the door and cabinet leaves, with a first pin connecting the door and intermediate leaves and a second pin connecting the cabinet and intermediate leaves together. Thus, the door is pivotal approximately 270° between open and closed positions. The first pin is hidden within the door. The intermediate leaf includes a curved portion extending between the door and cabinet leaves and extending through an opening in the door. A cam ramp is provided on the intermediate leaf and/or the cabinet leaf so as to provide greater torsional resistance between the cabinet and intermediate leaves compared to the door and intermediate leaves. The cam ramp controls the order of operation of the hinge leaves, such that the intermediate leaf pivots sequentially about the first and second pins, respectively. This controlled pivoting action eliminates or minimizes damage and wear to the door seal.

### BRIEF DESCRIPTION OF THE DRAWINGS

FIG. 1 is a perspective view of an appliance having a pair of doors pivotally mounted to a cabinet with the hinges of the present invention.

FIG. 2 is a sectional view taken along lines 2-2 of FIG. 1 with the doors in the closed position.

FIG. 3 is a sectional view similar to FIG. 2, but with the doors in an open position.

FIG. 4 is an enlarged sectional view taken along lines 4-4 of FIG. 2.

FIG. 5 is an enlarged sectional view taken along liens 5-5 of FIG. 3.

FIG. 6 is an exploded partial perspective view of the appliance cabinet, door and hinge.

FIG. 7 is a perspective view of the hinge. FIG. 8 is an exploded view of the hinge.

### DETAILED DESCRIPTION OF THE PREFERRED EMBODIMENT

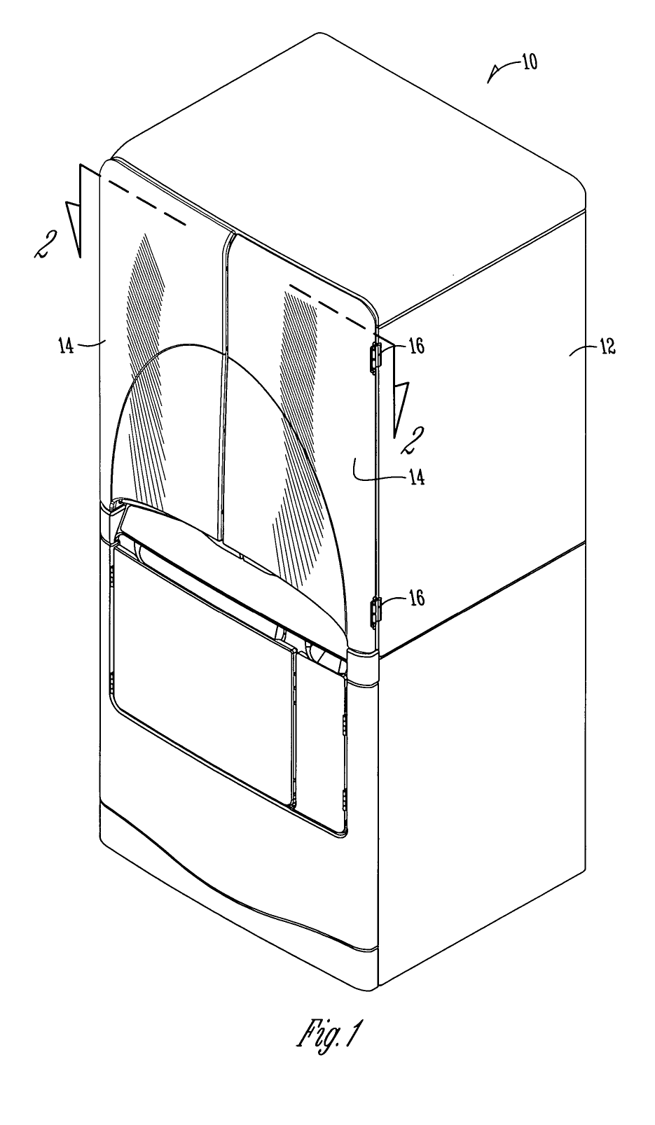

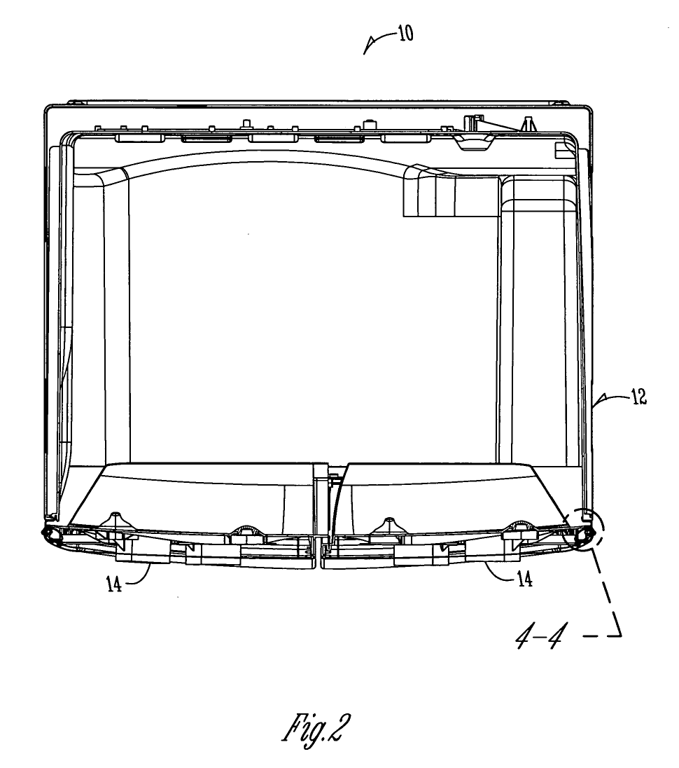

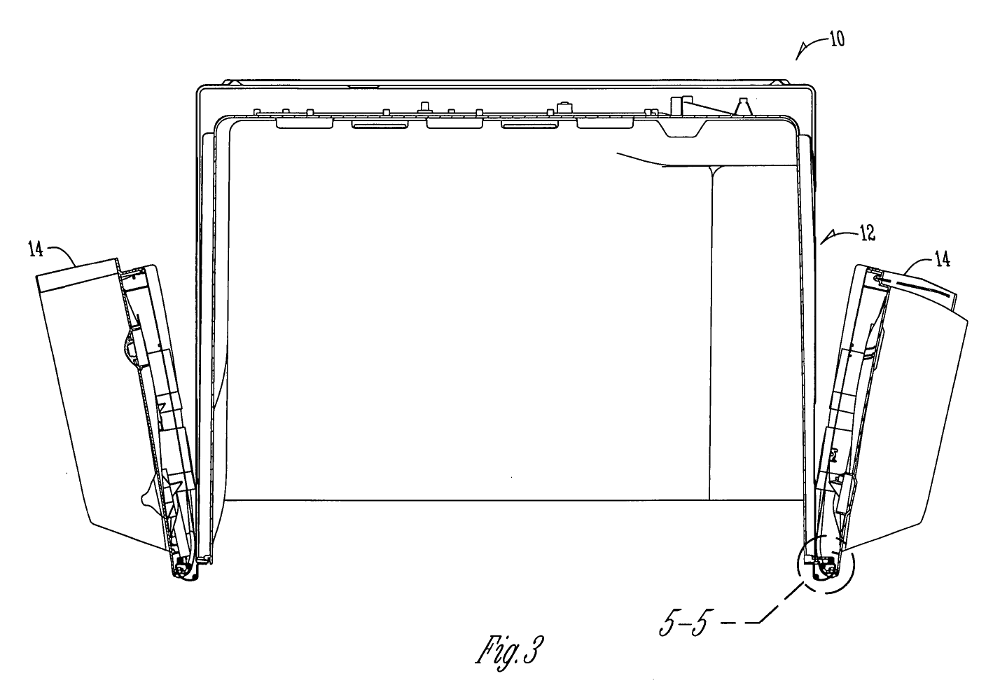

An appliance, such as a combination cabinet and tumble dryer 10, as shown in FIG. 1, and includes a cabinet 12 and a pair of doors 14 that are pivotally mounted to the cabinet 12 for movement between open and closed positions. Each door 14 includes upper and lower hinges 16 which allow the door 14 to pivot approximately 270° between the closed position, shown in FIG. 2, and the fully open position, shown in FIG. 3.

It is understood that the hinges 16 may be used on any cabinet and door structure, in addition to the dryer 10 shown in the drawings. Also, the structure may have a single door, rather than the double doors 14 shown on the dryer 10.

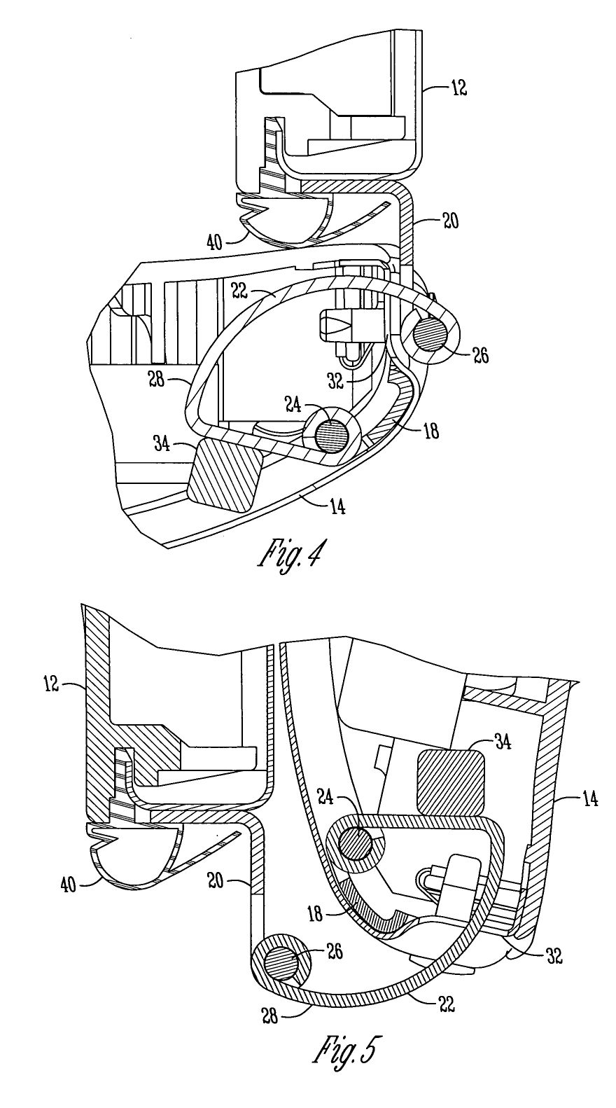

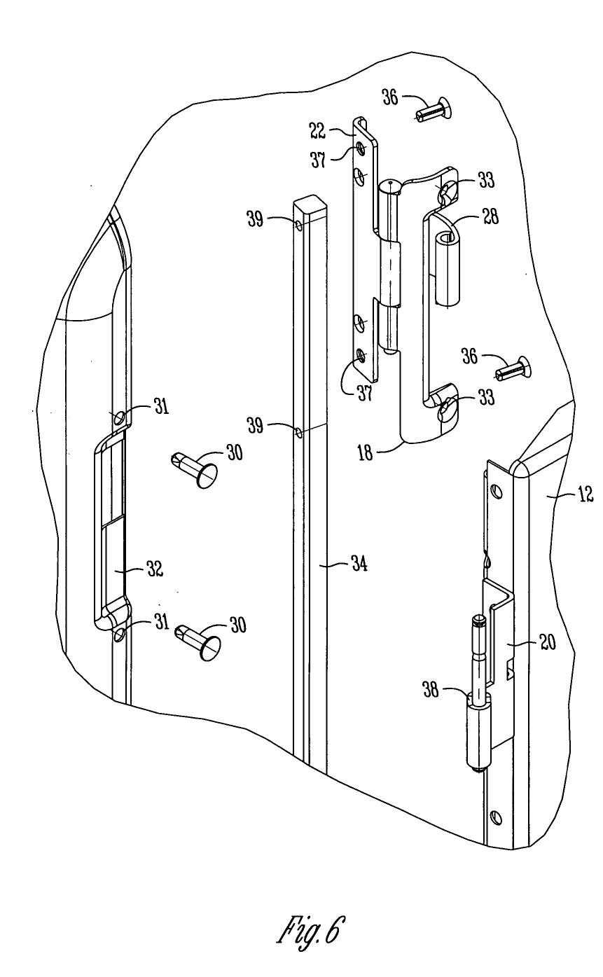

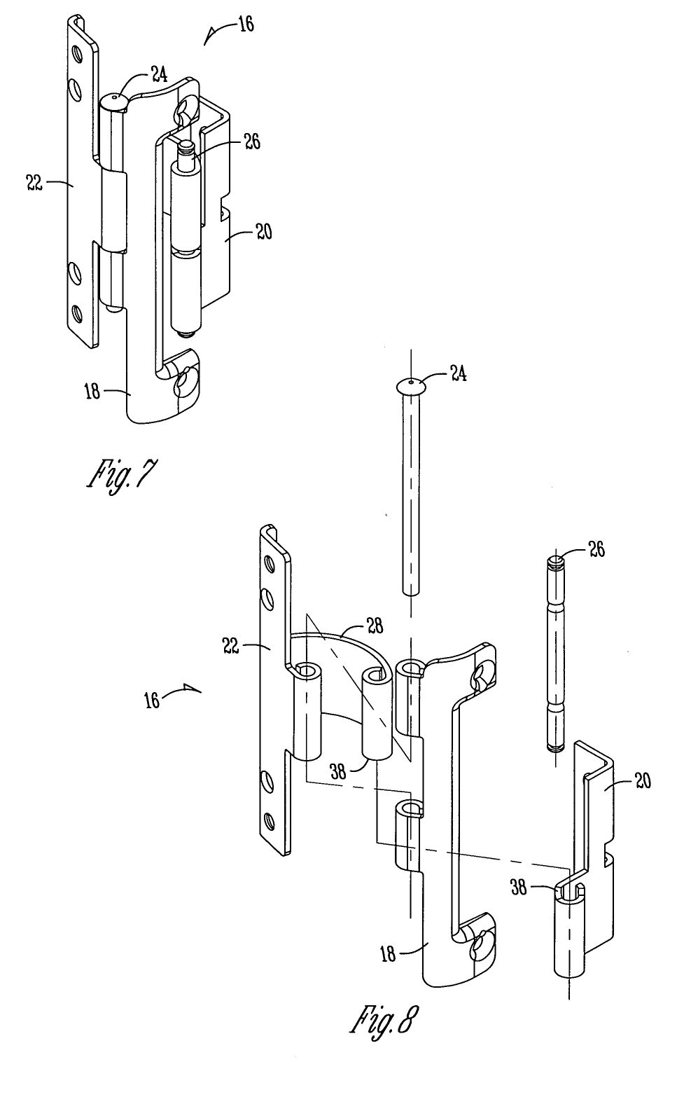

Each hinge 16 includes a door leaf 18, a cabinet leaf 20, and an intermediate leaf 22. The intermediate leaf 22 extends between the door leaf 18 and the cabinet leaf 20. A first pin 24 connects the intermediate leaf 22 to the door leaf 18, and a second pin 26 interconnects the intermediate leaf 22 to the cabinet leaf 20. As best seen in FIGS. 4, 5 and 8, the intermediate leaf 22 includes a curved arm 28 extending between the door leaf 18 and the cabinet leaf 22. The arm 28 is curved substantially about a radius centered at the first pin 24.

The door leaf 18 is mounted inside the door 14 in any convenient manner, such as with screws or rivets 30 extending through holes 31 in the door 14 and through the holes 33 in the door leaf 18. The cabinet leaf 20 is mounted to an external portion of the cabinet 12 in any convenient manner. The curved arm 28 of the intermediate leaf 22 extends through an opening 32 in the door 14.

The upper and lower hinges 16 on each door 14 are interconnected by a rod 34. The rod 34 is mounted to the intermediate leaf 22 in any convenient manner, such as by screws or rivets 36 extending through holes 37 in the leaf 22 and through the holes 39 in the rod 34. The rod 34 assures that the upper and lower hinges function in unison and minimizes undesirable twisting of the door 14. In an alternate embodiment, rod 34 may be replaced by a single hinge pin (not shown) to replace first pins 24 of a pair of hinges 16.

In an appliance, such as the dryer 10, the doors 14 includes seals 40 which sealingly engage with the cabinet 12 when the doors 14 are in the closed position. With such an appliance, it is desirable to control the order of operation of the hinge leaves 18, 20, 22, at least during the closing of the doors 14 so as to make or minimize damage and wear to the seals 40.

Each of the hinge pins 24 and 26 define first and second pivot axes. Door leaf 18 pivots about first pin 24 and then intermediate leaf 22 pivots about the second pin 26. Means are provided to control the order of pivotal movement of the first pin 24 and second pin 26. In the preferred embodiment, the means is a cam ramp 38 on the cabinet leaf 20. Due to the gravitational force of the door 14 on the hinge 16, torsional resistance to motion is produced as the intermediate leaf 22 rides up the inclined cam ramp 38 on the cabinet leaf 20. The resulting torsional resistance is therefore greater during pivoting of the intermediate-to-cabinet leaves than in pivoting of the intermediate-to-door leaves. This increased torsional resistance ensures full closure of the intermediate-to-door leaves combination 22-18, prior to the intermediate-to-cabinet leaf combination 22-20 pivotal movement.

As an alternative control means the cam ramps may be replaced with many different types of interengaging features. Examples include, but are not limited to, two protrusions, a protrusion and a cam ramp or a protrusion and a detent. Another alternative detent arrangement includes a coil spring/ball arrangement, wherein the detent is designed to provide a torsional resistance in the intermediate-to-cabinet leaves combination 22-20, which is greater than the torsional resistance in the intermediate-to-door leaves combination 22-18. In all the leaf control mechanisms, operational resistance is low enough to be comfortable to the user.

In operation, as each door 14 is moved from the closed position shown in FIG. 2, the intermediate leaf 22 initially pivots about the second pivot 26 due to the greater surface area contact at first pin 24 in comparison to the surface area contact at second pin 26, after which the intermediate leaf 22 pivots about the first pin 24 until the door is opened 270°. In closing the door, the door leaf 18 first pivots about the first pin 24 due to the interengagement of cam ramps 38 at second pin 26, then intermediate leaf 22 pivots about the second pin 26. This controlled order of pivotal movement of the intermediate leaf 22 and door leaf 18 assures that the door closes properly upon its seals 40 while minimizing damage and wear to the seals.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. In combination with a cabinet and a door, a hinge for pivotally connecting the door to the cabinet, comprising:
a door leaf mounted within the door;
a cabinet leaf mounted on an exterior surface of the cabinet; and
an intermediate leaf interconnecting the door and cabinet leaves so as to allow the door to pivot between open and closed positions.

2. The hinge of claim 1 further comprising a first pin connecting the door leaf and intermediate leaf together and a second pin connecting the cabinet leaf and intermediate leaf together.

3. The hinge of claim 2 wherein the first pin is within the door.

4. The hinge of claim 2 wherein the intermediate leaf pivots about the second pin and then the door leaf pivots about the first pin when opening the door.

5. The hinge of claim 2 wherein the cabinet leaf is fixed relative to the second pin and the intermediate leaf pivots about the second pin.

6. The hinge of claim 2 wherein the door leaf pivots about the first pin and then the intermediate leaf pivots about the second pin when closing the door.

7. The hinge of claim 2 wherein the door leaf and intermediate leaf pivot about the first and second pins to allow the door to swing approximately 270° relative to the cabinet.

8. The hinge of claim 2 wherein at least one of the cabinet leaf and intermediate leaf includes a cam ramp to delay full pivotal movement about the second pin until pivotal movement about the first pin is complete.

9. The hinge of claim 1 wherein the door leaf and the intermediate leaf pivots sequentially about the first and second pins.

10. The hinge of claim 9 wherein the sequential pivot operation of the first and second pins is reversed between the opening and closing operations.

11. The hinge of claim 1 wherein the intermediate leaf includes a first end within the door and a second end outside the door.

12. The hinge of claim 9 wherein the intermediate leaf has a curved portion extending between the first and second ends and extending through an opening in the door.

13. A cabinet comprising:
a plurality of walls defining a door opening;
a door mounted on one of the walls so as to move between open and closed positions relative to the door opening; and
a pair of hinges for pivotally mounting the door to the one wall, each hinge including first and second pivot pins, with at least one of the pins being substantially hidden within the cabinet.

14. The cabinet of claim 13 further comprising a rod interconnecting the pair of hinges.

15. The cabinet of claim 13 wherein each hinge includes a door leaf, a cabinet leaf, and an intermediate leaf, with the door leaf and intermediate leaf connected by the first pivot pin, and the cabinet leaf and intermediate leaf connected by the second pivot pin.

16. The cabinet of claim 15 wherein the door leaf is mounted within the door, the cabinet leaf is mounted to the one cabinet wall, and the intermediate leaf interconnects the door and cabinet leaves.

17. The cabinet of claim 16 wherein the intermediate leaf has a first end inside the door and a second end outside the door.

18. The cabinet of claim 15 wherein the first pin is within the door.

19. The cabinet of claim 15 wherein the door leaf and cabinet leaf are fixed with respect to the door and the cabinet, the door leaf pivots about the first pin, and the intermediate leaf pivots about the second pin.

20. The cabinet of claim 18 wherein the pivotal movement occurs sequentially about the first and second pins.

21. The cabinet of claim 15 wherein the intermediate leaf has a curved portion extending between the door leaf and cabinet leaf.

22. The cabinet of claim 15 wherein the intermediate leaf has a curved portion extending through an opening in the door.

23. The cabinet of claim 21 wherein the curved portion is substantially a radius centered at the first pivot pin.

24. The cabinet of claim 13 wherein the hinges pivot about the pins to allow the door to swing approximately 270° relative to the one wall.

25. In combination with a cabinet and door, a hinge for pivotally connecting the door to the cabinet, comprising:
a door leaf mounted on the door;
a cabinet leaf mounted on the cabinet;
an intermediate leaf interconnecting the door and cabinet leaves; and
means for controlling the order of operation of the leaves.

26. The hinge of claim 25 further comprising a first pin to connect the door leaf and intermediate leaf and a second pin to connect the cabinet leaf and intermediate leaf.

27. The hinge of claim 26 wherein the means provides greater torsional resistance between the cabinet leaf and intermediate leaf than between the door leaf and intermediate leaf when closing the door.

28. The hinge of claim 26 wherein the means includes a cam ramp on at least one of the cabinets leaf and intermediate leaf.

29. In combination with a cabinet and door, a hinge for pivotally connecting the door to the cabinet, comprising:
a door leaf mounted on the door;
a cabinet leaf mounted on the cabinet;
an intermediate leaf interconnecting the door leaf and cabinet leaf; and
torsional resistance between the cabinet leaf and the intermediate leaf being greater than torsional resistance between the door leaf and the intermediate leaf.

30. The hinge of claim 29 further comprising a first pin to connect the door leaf and intermediate leaf and a second pin to connect the cabinet leaf and intermediate leaf.

31. The hinge of claim 29 further comprising a cam ramp on at least one of the cabinet leaf and intermediate leaf to increase the torsional resistance therebetween.
